(19) United States
(12) Patent Application Publication
(10) Pub. No.: US 2025/0309946 A1
(43) Pub. Date: Oct. 2, 2025

(54) CONTROL DEVICE, CODEBOOK GENERATION DEVICE, CONTROL METHOD, CODEBOOK GENERATION METHOD, AND PROGRAM

(71) Applicant: TOHOKU UNIVERSITY, Sendai-shi, Miyagi (JP)

(72) Inventors: Yuichi KAWAMOTO, Sendai-shi (JP); Hiroaki HASHIDA, Sendai-shi (JP); Ryuhei HIBI, Sendai-shi (JP); Nei KATO, Sendai-shi (JP)

(21) Appl. No.: 18/849,223

(22) PCT Filed: Mar. 30, 2022
(86) PCT No.: PCT/JP2022/016069

§ 371 Date: Sep. 20, 2024

(51) Int. Cl. H04B 7/04; H04B 7/0456; H04W 64/00

(52) U.S. Cl. CPC H04B 7/04026; H04B 7/0456; H04W 64/00

(57) ABSTRACT

A control device includes: a control pattern selection unit configured to select a control pattern for an IRS based on a codebook and a reference value acquired from a target of the IRS, the codebook indicating a correspondence relation between a representative value specified based on the reference value and the control pattern for the IRS; and a control unit configured to control the IRS based on the control pattern. The codebook is generated by clustering a plurality of reference value samples of a target of an IRS into a plurality of clusters, calculating a representative value in each cluster based on reference values clustered in each cluster, calculating a control pattern corresponding to the representative value, and calculating a correspondence relation between the representative value and the control pattern.

### TECHNICAL FIELD

The present invention relates to a control device, a codebook generation device, a control method, a codebook generation method, and a program.

### BACKGROUND ART

An intelligent reflecting surface (IRS) is a device that improves network performance. The IRS is a device in which metamaterial elements are integrated. The metamaterial elements are minute structures whose electromagnetic characteristics can be freely controlled. By controlling the metamaterial elements, an electromagnetic wave incident on the device can be reflected in any direction. Usually, channel state information (CSI) is required to grasp an electromagnetic wave environment when the IRS is to be controlled.

### CITATION LIST

### Non Patent Literature

Non Patent Literature 1: H. Guo, Y. Liang, J. Chen and E. G. Larsson, “Weighted Sum-Rate Maximization for Reconfigurable Intelligent Surface Aided Wireless Networks,” in IEEE Transactions on Wireless Communications, vol. 19, no. 5, pp. 3064-3076

### SUMMARY OF INVENTION

### Technical Problem

However, the IRS is a passive device, and cannot transmit and receive information. Therefore, a device that collects the CSI needs to be provided separately from the IRS and connected to the IRS. Therefore, a cost is increased, and a technical burden is imposed.

The invention is made in view of the above problem, and an object thereof is to provide a control device capable of controlling an IRS without requiring CSI.

### Solution to Problem

An aspect of the invention is a control device including: a control pattern selection unit configured to determine a control pattern for an IRS which corresponds to a representative value in a cluster the same as a reference value of a reflection target based on the reference value and a codebook indicating a correspondence relation between the representative value and the control pattern; and a control unit configured to control the IRS based on the control pattern. The codebook is generated by classifying reference values into clusters, generating the representative value in each of the clusters, and generating the control pattern corresponding to the representative value.

### Advantageous Effects of Invention

According to the invention, it is possible to control the IRS without requiring the CSI.

### BRIEF DESCRIPTION OF DRAWINGS

FIG. 1 is a diagram showing a configuration example of an electromagnetic wave control system 1 according to the present embodiment.

FIG. 2 is a diagram showing a configuration example of a control device 20 according to the present embodiment.

FIG. 3 is a diagram showing a configuration example of a codebook generation device 30 according to the present embodiment.

FIG. 4 is a diagram showing an example of representative values.

FIG. 5 is a flowchart showing an operation of the control device 20.

FIG. 6 is a flowchart showing an operation of the codebook generation device 30.

FIG. 7 is a diagram showing a simulation environment.

FIG. 8 is a diagram showing parameters in the simulation.

FIG. 9 is a diagram showing representative values generated by a second method.

FIG. 10 is a diagram showing a comparison of SNRs when positions of targets 50 are uniformly distributed.

FIG. 11 is a diagram showing a comparison of SNRs when the positions of the targets 50 are set in a manner of Gaussian distribution.

### DESCRIPTION OF EMBODIMENTS

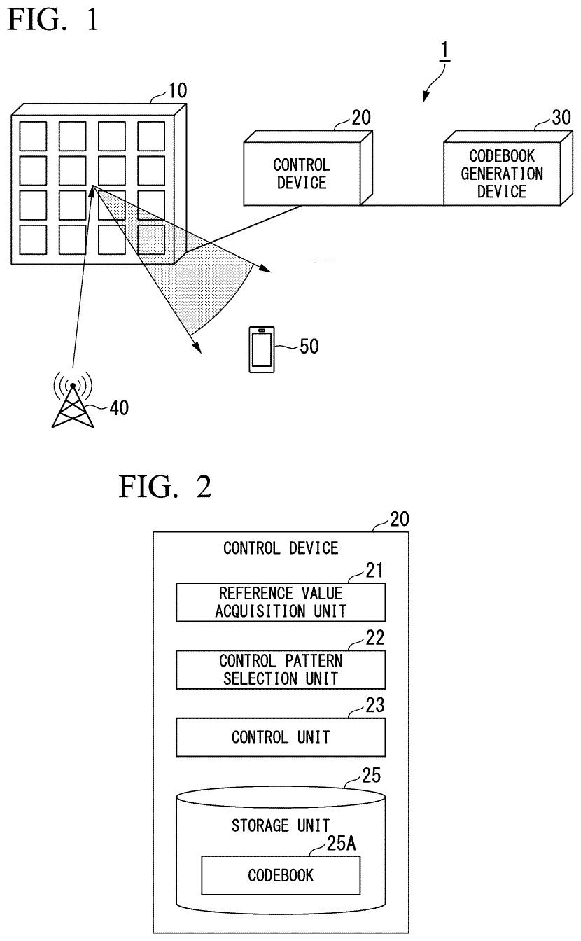

FIG. 1 is a diagram showing a configuration example of an electromagnetic wave control system 1 according to the present embodiment. The electromagnetic wave control system 1 includes an IRS 10, a control device 20, and a codebook generation device 30. In the electromagnetic wave control system 1, the IRS 10 is controlled by the control device 20 such that an electromagnetic wave incident from, for example, a wave source 40 (for example, a base station (BS)) to the IRS 10 is reflected in a direction of a target 50 (for example, user equipment (UE)). The control performed by the control device 20 is based on a codebook generated by the codebook generation device 30.

FIG. 2 is a diagram showing a configuration example of the control device 20 according to the present embodiment. The control device 20 includes a reference value acquisition unit 21, a control pattern selection unit 22, a control unit 23, and a storage unit 25. The storage unit 25 includes a codebook 25A.

The reference value acquisition unit 21 acquires a reference value of the target 50. The reference value of the target 50 is, for example, position information of the target 50. The reference value acquisition unit 21 acquires the position information of the target 50 collected by, for example, an antenna 11 or a sensor 12. The antenna 11 or the sensor 12 collects the position information of the target 50 using, for example, an electromagnetic wave in a frequency band lower than that of the electromagnetic wave emitted by the wave source 40. The antenna 11 or the sensor 12 is provided by, for example, the IRS 10.

The control pattern selection unit 22 selects a control pattern for the IRS 10 based on the reference value acquired by the reference value acquisition unit 21 and the codebook 25A stored in the storage unit 25. The codebook 25A indicates a correspondence relation between a representative value and a control pattern. The control pattern selection unit 22 determines, as a pattern for control performed by the control unit 23, a control pattern corresponding to a representative value which is in a cluster the same as the reference value acquired by the reference value acquisition unit 21. A method for generating the codebook 25A will be described later.

The control unit 23 controls the IRS 10 based on the control pattern selected by the control pattern selection unit 22.

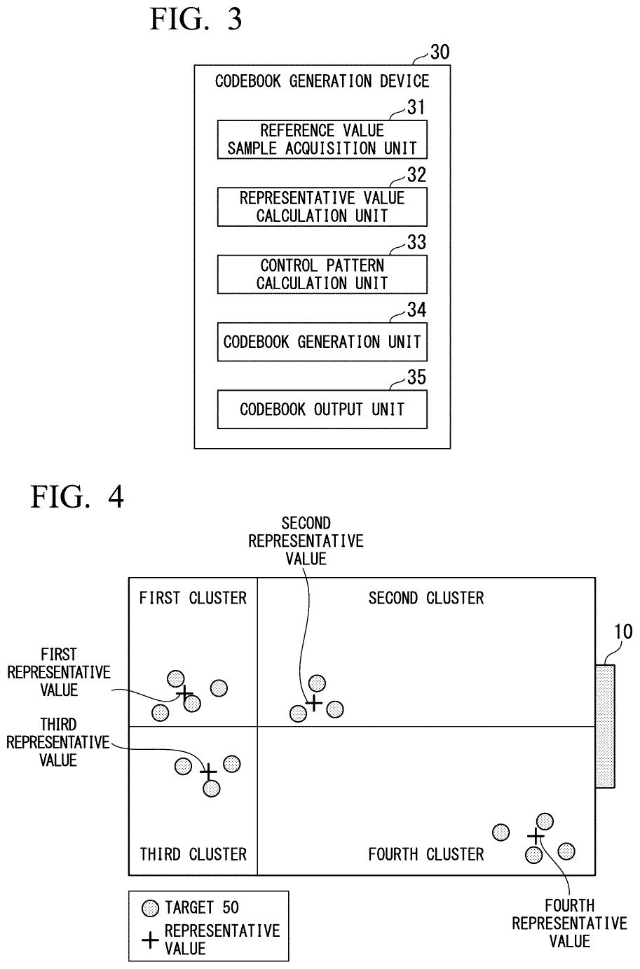

FIG. 3 is a diagram showing a configuration example of the codebook generation device 30 according to the present embodiment. The codebook generation device 30 includes a reference value sample acquisition unit 31, a representative value calculation unit 32, a control pattern calculation unit 33, a codebook generation unit 34, and a codebook output unit 35.

The reference value sample acquisition unit 31 acquires a plurality of reference value samples of the target 50. The reference value of the target 50 is, for example, the position information of the target 50. The reference value sample acquisition unit 31 acquires a data set of reference values created for generating the codebook, and may also acquire the reference values by a method similar to that used by the reference value acquisition unit 21.

The representative value calculation unit 32 calculates the representative value based on the reference value acquired by the reference value sample acquisition unit 31. The number k of the representative values to be calculated is set to any integer equal to or greater than 2 in advance. The representative value calculation unit 32 calculates the representative values by a following procedure. First, the representative value calculation unit 32 clusters the reference value samples into clusters whose number is the same as the number k of the representative values based on values of the samples. For example, when the reference value is the position information, the sample is clustered into the cluster based on a position indicated by the position information. Thereafter, in each cluster, an average of the reference values included in the cluster is used as a representative value. For example, when the reference value is the position information, the representative value is a center of the positions indicated by the position information.

Thereafter, the representative value calculation unit 32 calculates a sum of differences between the representative value and the reference values in each cluster as “distortion” in respective clusters. For example, when the reference value is the position information, the difference between the representative value and the reference value is a distance between a position indicated by the representative value and the position indicated by the position information.

The representative value calculation unit 32 calculates a sum of the “distortion” in the respective clusters. The representative value calculation unit 32 determines the clustering of the reference value into each cluster such that the sum of the “distortion” is the minimum. This is achieved by using, for example, a k-means algorithm. Finally, the representative value calculation unit 32 determines the representative values when the sum of the “distortion” in the respective clusters is minimum.

The k-means algorithm is expressed by Formula (1).

$$\begin{matrix}[ Math 1 ] & \\ {arg min}_{{S}_{n}} \frac{1}{{M}_{n}} {\sum }_{m = 1}^{{M}_{n}} d ( {V}_{n , m} , {S}_{n} ) & ( 1 )\end{matrix}$$

In Formula (1), Sₙ is a representative value in a nth cluster, Mₙ is the number of reference values in the nth cluster, V_{n,m} is a mth reference value in the nth cluster, and d(a, b) is a function that outputs a difference between a and b. By calculating Formula (1), the representative values when the sum of the “distortion” in the respective clusters is minimum are calculated.

FIG. 4 is a diagram showing an example of representative values. Four representative values from a first representative value to a fourth representative value are calculated, and reference value samples of the target 50 are classified into clusters from a first cluster to a fourth cluster.

The method for calculating the representative values by the representative value calculation unit 32 is not limited to the above method, and the representative values may be calculated by another statistical method or optimization method.

The control pattern calculation unit 33 calculates a control pattern for each of the representative values when the sum of the “distortion” in the respective clusters is minimum. When the reference value is the position information, the control pattern calculation unit 33 calculates the control such that the pattern electromagnetic wave incident on the IRS 10 is reflected and reaches a position indicated by the representative value.

The codebook generation unit 34 generates the codebook based on the representative value and the corresponding control pattern. The codebook output unit 35 outputs the codebook generated by the codebook generation unit 34 to the control device 20. The control device 20 stores the input codebook in the storage unit 25.

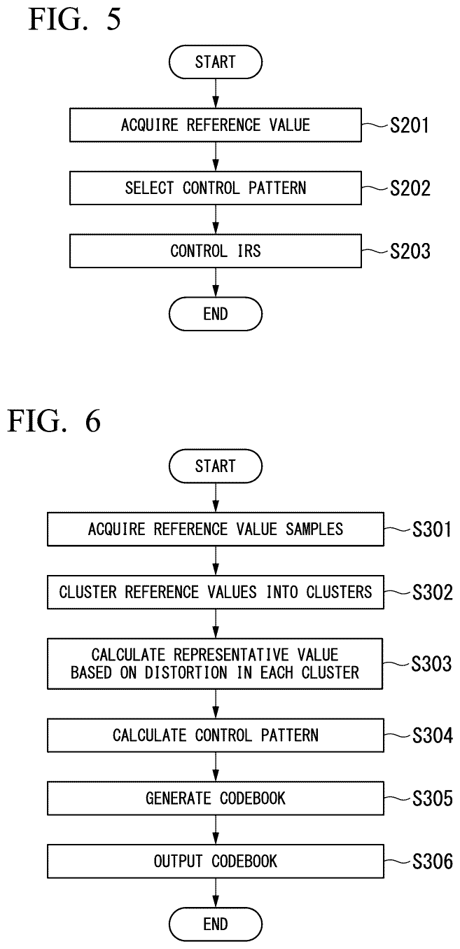

FIG. 5 is a flowchart showing an operation of the control device 20. First, the reference value acquisition unit 21 acquires a reference value of the target 50 (step S201). Next, the control pattern selection unit 22 selects a control pattern based on the reference value and a codebook (step S202). The control unit 23 controls the IRS 10 based on the determined control pattern.

FIG. 6 is a flowchart showing an operation of the codebook generation device 30. First, the reference value sample acquisition unit 31 acquires reference value samples of the target 50 (step S301). Next, the representative value calculation unit 32 clusters the reference value samples into a plurality of clusters (step S302). Thereafter, the representative value calculation unit 32 calculates a representative value based on distortion in each of the clusters (step S303). The control pattern calculation unit 33 calculates a control pattern corresponding to the generated representative value (step S304). The codebook generation unit 34 generates a codebook based on the representative value and the corresponding control pattern (step S305). The codebook output unit 35 outputs the generated codebook (step S306).

### Simulation

Hereinafter, SNRs of the electromagnetic waves reaching the target 50 when the control device 20 controls the IRS 10 based on the codebooks generated by the two methods are compared.

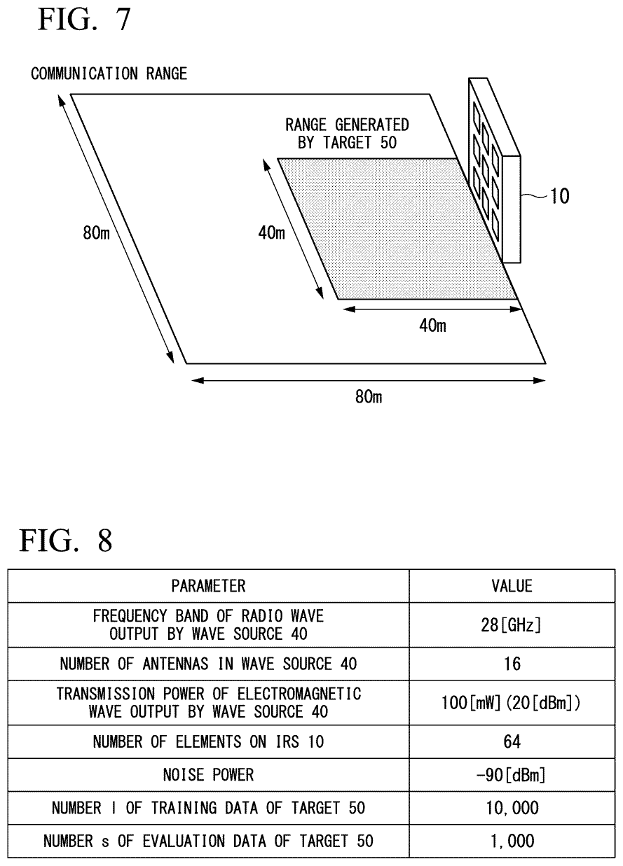

FIG. 7 shows a simulation environment. While a range generated by the target 50 is a square of 40 m×40 m, a communication range is set to a square of 80 m×80 m, and an area of the range generated by the target 50 is ¼ of an area of the communication range. As will be described later, the cluster when the representative value is to be generated is generated based on the communication range, and thus it can be said that the range generated by the target 50 is local.

Positions of reflection targets in the range generated by the target 50 are uniformly distributed and set in a manner of Gaussian distribution with a center of the range generated as an average. By setting the positions of the reflection targets in a manner of Gaussian distribution, the position of the reflection target is set to a more local position. The variance v² of the Gaussian distribution is 10.

FIG. 8 is a diagram showing parameters in the simulation. The wave source 40 is configured such that a frequency of an output electromagnetic wave is set to 28 GHz, 16 antennas are provided, and a transmission power of an output electromagnetic wave is set to 100 mW (20 dBm). The electromagnetic wave output from the wave source 40 is set to be incident on a center of the IRS 10. The number of elements on the IRS 10 is set to 64. A noise power is set to −90 dbm. The number of training data of the target 50 for generating the codebook is set to 10,000. The number of evaluation data of the target 50 for evaluating the codebook is set to 1000.

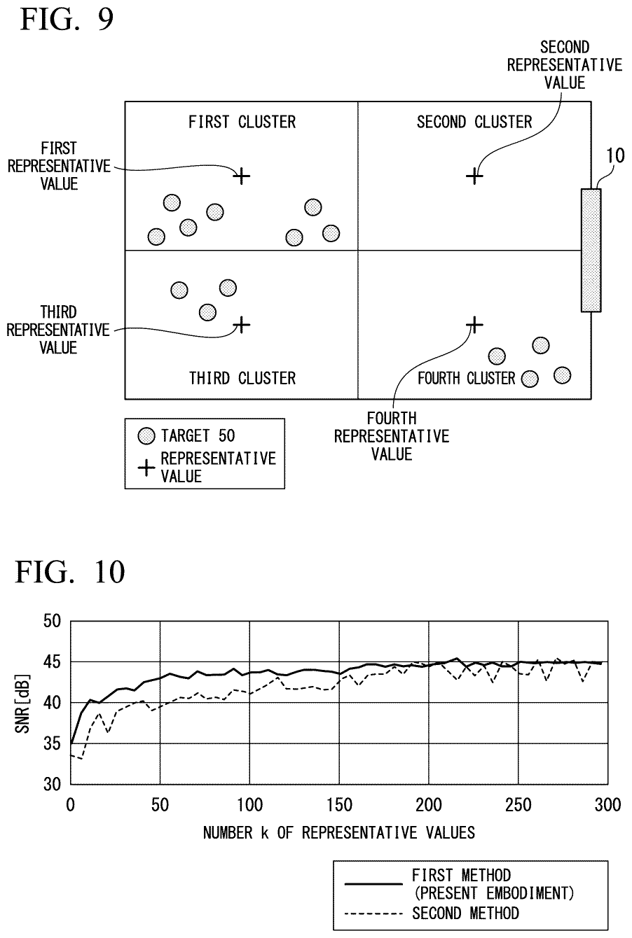

In this simulation, the codebook is generated by two methods. A first method is the same as the method performed by the codebook generation device 30 in the present embodiment. That is, the representative values are calculated by dividing the communication range into the clusters whose number is the same as the number k of the representative values based on the positions of the samples of the target 50 which are the training data. In a second method, the communication range is divided into clusters having equal sizes, and the representative value is calculated by taking a center of each cluster as the representative value. That is, in the second method, the representative value is not calculated based on the positions of the samples of the targets 50 which are the training data. FIG. 9 is a diagram showing representative values calculated by the second method. In the second method, since the representative value is not generated based on the positions of the samples of the target 50 which are the training data, for example, the target 50 is not included in a second cluster.

This simulation assumes communication using multi-input and single-output (MISO) transmission. An electromagnetic wave that directly reaches the target 50 from the wave source 40 is ignored. The SNR of the target 50 is expressed by Formula (2).

$$\begin{matrix}[ Math 2 ] & \\ SNR = \frac{P {\vert H Θ Gw \vert}^{2}}{{σ}^{2}} & ( 2 )\end{matrix}$$

In Formula (2), P is a power of the electromagnetic wave output by the wave source 40, H is a propagation channel response between the IRS 10 and the target 50, Θ is a phase shift of the IRS 10, G is a propagation channel response between the wave source 40 and the IRS 10, and w is a weight of the electromagnetic wave output by the wave source 40. Optimization of Θ and w can be regarded as an optimization problem with a non-linear constraint, and is performed using a constrained optimization by linear approximation method (COBYLA method).

A codebook is created by changing the number k of the representative values according to the first method and the second method. An average value of the SNRs of the electromagnetic waves reaching the target 50 when the IRS 10 is controlled based on the created codebook and the target 50 that is the evaluation data is calculated.

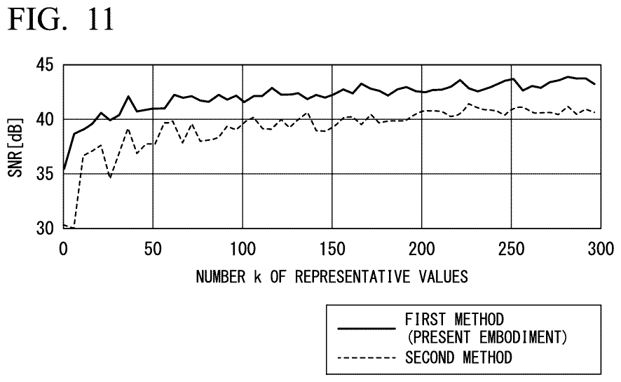

FIG. 10 is a diagram showing a comparison of SNRs when the positions of the targets 50 are uniformly distributed. FIG. 11 is a diagram showing a comparison of SNRs when the positions of the targets 50 are set in a manner of Gaussian distribution. When the positions of the targets 50 are uniformly distributed and k is 200 or more, the SNR in the second method may be larger than the SNR in the first method, but in other cases, the SNR in the first method is greater than the SNR in the second method. In particular, when the positions of the targets 50 are set in a manner of the Gaussian distribution and the positions of the targets 50 are localized, the SNR in the first method is significantly larger than the SNR in the second method.

In this way, in the electromagnetic wave control system 1, the control device 20 selects the control pattern based on the codebook, which indicates the correspondence relation between the representative value specified based on the reference value acquired from the target 50 and the control pattern for the IRS, and the reference value, and controls the IRS 10. The codebook is generated by the codebook generation device 30. The codebook generation device 30 generates the codebook by clustering the plurality of reference value samples of the IRS target into the plurality of clusters, calculating the representative value in each cluster based on the reference values clustered in each cluster, calculating the control pattern corresponding to the representative value, and calculating the correspondence relation between the representative value and the control pattern. Therefore, the IRS 10 can be controlled based on the reference value, and the IRS 10 can be controlled without CSI.

### Other Embodiments

As described above, the embodiment of the invention has been described in detail with reference to the drawings, but specific configurations are not limited to the embodiment, and a design and the like within a range not departing from the gist of the invention are also included.

In the description of the present embodiment, an example has been described in which the position information is used as the reference value, but the reference value is not limited thereto. For example, the reference value may be a direction, a velocity, or an acceleration of movement of the target 50, and may include a plurality of parameters thereof. The representative value calculation unit 32 may adjust a size and a shape of the cluster based on the direction, the speed, the acceleration, and the like of the movement of the target 50. The reference value may be a photograph from a viewpoint of the target 50, and the information relating to the position may be acquired by processing the photograph.

A program for implementing all or a part of functions of the control device 20 and the codebook generation device 30 according to the invention may be recorded on a computer-readable recording medium. All or a part of processes performed by the control device 20 and the codebook generation device 30 may be performed by causing a computer system to read and execute the program recorded on the recording medium. The “computer system” herein includes an OS and hardware such as a peripheral device. In addition, the “computer system” includes a WWW system having a home page providing environment (or display environment).

The “computer-readable recording medium” refers to a storage device, for example, a portable medium such as a flexible disk, a magneto-optical disk, an ROM, and a CD-ROM, and a hard disk built in the computer system. Further, the “computer-readable recording medium” also includes one that holds a program for a certain period, such as a volatile memory (RAM) in a computer system serving as a server or a client when the program is transmitted via a network such as the Internet or a communication line such as a telephone line.

The program may be transmitted from a computer system in which the program is stored in a storage device or the like to another computer system via a transmission medium or a transmission wave in the transmission medium. Here, the “transmission medium” that transmits the program refers to a medium having a function of transmitting information, for example, a network (communication network) such as the Internet or a communication line (communication wire) such as a telephone line. The program may be a program for implementing a part of the functions described above. Further, the program may be a so-called differential file (differential program) that can implement the functions described above in combination with a program already recorded in the computer system.

### REFERENCE SIGNS LIST

1: electromagnetic wave control system
10: IRS
20: control device
21: reference value acquisition unit
22: control pattern selection unit
23: control unit
25: storage unit
25A: codebook
30: codebook generation device
31: reference value sample acquisition unit
32: representative value calculation unit
33: control pattern calculation unit
34: codebook generation unit
35: codebook output unit
40: wave source
50: target

1. A control device comprising:
a control pattern selection unit configured to select a control pattern for an IRS based on a codebook and a reference value acquired from a target of the IRS, the codebook indicating a correspondence relation between a representative value specified based on the reference value and the control pattern for the IRS; and
a control unit configured to control the IRS based on the control pattern, wherein the codebook is generated by clustering a plurality of reference value samples of a target of an IRS into a plurality of clusters, calculating a representative value in each cluster based on reference values clustered in each cluster, calculating a control pattern corresponding to the representative value, and calculating a correspondence relation between the representative value and the control pattern.

2. The control device according to claim 1, wherein
the reference value is position information.

3. The control device according to claim 1, wherein
the representative value in the codebook is generated by calculating distortion in respective clusters, which is a sum of differences between a representative value and a plurality of reference value samples, and minimizing a sum of the distortion calculated in the respective clusters.

4. A codebook generation device, wherein
a plurality of reference value samples of a target of an IRS are clustered into a plurality of clusters,
a representative value in each cluster is calculated based on reference values clustered in each cluster,
a control pattern corresponding to the representative value is calculated, and
a codebook is generated by calculating a correspondence relation between the representative value and the control pattern.

5. The codebook generation device according to claim 4, wherein
the reference value is position information.

6. The codebook generation device according to claim 4, wherein
the representative value is generated by calculating distortion in respective clusters, which is a sum of differences between a representative value and the reference values, and minimizing a sum of the distortion calculated in the respective clusters.

7. A control method comprising:
a control pattern selection step of selecting a control pattern for an IRS based on a codebook and a reference value acquired from a target of the IRS, the codebook indicating a correspondence relation between a representative value specified based on the reference value and the control pattern for the IRS; and
a control step of controlling the IRS based on the control pattern, wherein
the codebook is generated by clustering a plurality of reference value samples of a target of an IRS into a plurality of clusters, calculating a representative value in each cluster based on reference values clustered in each cluster, calculating a control pattern corresponding to the representative value, and calculating a correspondence relation between the representative value and the control pattern.

8. (canceled)

9. A non-transitory computer-readable recording medium storing a program that causes a computer to function as the control device according to claim 1.

10. A non-transitory computer-readable recording medium storing a program that causes a computer to function as the codebook generation device according to claim 4.

11. The control device according to claim 2, wherein
the representative value in the codebook is generated by calculating distortion in respective clusters, which is a sum of differences between a representative value and a plurality of reference value samples, and minimizing a sum of the distortion calculated in the respective clusters.

12. The codebook generation device according to claim 5, wherein the representative value is generated by calculating distortion in respective clusters, which is a sum of differences between a representative value and the reference values, and minimizing a sum of the distortion calculated in the respective clusters.

13. A non-transitory computer-readable recording medium storing a program that causes a computer to function as the control device according to claim 2.

14. A non-transitory computer-readable recording medium storing a program that causes a computer to function as the control device according to claim 3.

15. A non-transitory computer-readable recording medium storing a program that causes a computer to function as the codebook generation device according to claim 5.

16. A non-transitory computer-readable recording medium storing a program that causes a computer to function as the codebook generation device according to claim 6.
